(19) United States
(12) Patent Application Publication
(10) Pub. No.: US 2015/0309248 A1
(43) Pub. Date: Oct. 29, 2015

(54) LED-BASED LIGHTING DEVICES AND SYSTEMS BASED ON LIGHT PANELS HAVING TRANSPARENT WAVEGUIDES

(71) Applicant: Axlen, Inc., Wilmington, DE (US)

(72) Inventor: Li Xu, Saratoga, CA (US)

(21) Appl. No.: 14/696,324

(22) Filed: Apr. 24, 2015

Related U.S. Application Data
(60) Provisional application No. 61/983,639, filed on Apr. 24, 2014.

(51) Int. Cl. F21V 8/00; F21S 19/00

(52) U.S. Cl. CPC G02B 6/0095; G02B 6/0068; G02B 6/0055; G02B 6/005; G02B 6/0088; G02B 6/0073; F21S 19/005; G02B 6/006; F21Y 2101/02

(57) ABSTRACT

Techniques, systems, and devices are disclosed for implementing a light window having LED light sources and a transparent waveguide to produce patterned illuminations and visual effects. In one aspect, a light window uses a light panel for producing an illumination or a visual effect, wherein the light panel includes: a transparent front panel; a transparent back panel; a side frame which supports the front panel and the back panel; multiple LEDs attached to an inner surface of the side frame; and a light guide positioned between the front panel and the back panel and configured to propagate light emitted by the LEDs, and to direct a portion of the light out of the light panel in a direction toward the front panel. One surface of the light guide is configured with either a refractive structure or a reflective structure for directing the portion of the light toward the front panel.

### PRIORITY CLAIM AND RELATED APPLICATION

This patent document claims the priority and benefits of U.S. Provisional Application No. 61/983,639, entitled “LED-BASED LIGHTING DEVICES AND SYSTEMS BASED ON LIGHT PANELS HAVING TRANSPARENT WAVEGUIDES” and filed on Apr. 24, 2014 by Axlen, Inc. and inventor Li Xu.

### TECHNICAL FIELD

This patent document relates to techniques, systems, and devices for lighting fixtures, structures or systems based on light-emitting diode (LED) lights.

### BACKGROUND

A light-emitting diode (LED) is a semiconductor light source. An LED includes semiconducting materials doped with impurities to create a p-n junction, in which electrical current can easily flow one directionally from the p-side (anode) to the n-side (cathode), but not in the reverse direction. Charge-carriers (e.g., electrons and holes) flow into the p-n junction from connecting electrodes at each end of the junction having different voltages. For example, when an electron combines with a hole, the electron falls into a lower energy level and can release energy in the form of a photon, e.g., emitting light. This effect is referred to as electroluminescence. The wavelength of the light emitted, and thus the color of the emitted light, depends on the band gap energy of the materials forming the p-n junction. For example, bright blue LEDs are based on the wide band gap semiconductors including GaN (gallium nitride) and InGaN (indium gallium nitride). LED devices can be used to emit white light that are energy-efficient alternative light sources for replacing some conventional light sources such as incandescent light bulbs and florescent lights. For producing white light using LEDs, one technique is to use individual LEDs that emit three primary colors (red, green, and blue) and then mix all the colors to form white light. Another technique is to use a phosphor material to convert monochromatic light from a blue or ultraviolet LED to broad-spectrum white light, e.g., in a similar manner to fluorescent light bulbs. LEDs are increasingly used to create light panels due to their high lumen efficiency, versatility in producing a wide range of colors, small in individual sizes and easiness to arrange a great number of LEDs into large configurations.

### SUMMARY

Techniques, systems, and devices are disclosed for implementing lighting structures, fixtures or systems having multiple light-emitting diodes (LEDs) and one or more transparent waveguides for providing basic illumination, and for producing various coloring and visual effects, including LED-illuminated windows, skylights, and other lighting structures for various applications at residential buildings, office buildings, commercial spaces, public spaces and other settings. The disclosed technology and designs can be used for providing basic illumination, and for producing various coloring and visual effects on the window for decoration, entertainment or advertisement purposes.

In one aspect of the disclosed technology, a light panel for producing an illumination or a visual effect includes: a transparent front panel; a transparent back panel; a side frame which supports the transparent front panel and the transparent back panel; multiple LEDs attached to an inner surface of the side frame; and a light guide positioned between the transparent front panel and the transparent back panel, wherein the light guide is configured to propagate light emitted by the multiple LEDs, and to direct a portion of the light out of the light panel in a direction toward the transparent front panel. The at least one surface of the light guide may be configured with either a refractive structure or a reflective structure for directing the portion of the light toward the transparent front panel. Notably, the light panel is substantially transparent when the multiple LEDs are turned off.

In some implementations, the at least one surface of the light guide includes a refractive structure composed of a group of refractive elements for both refracting and reflecting light emitted by the multiple LEDs into different angles.

In some implementations, the at least one surface of the light guide is the back surface facing the transparent back panel, wherein the group of refractive elements is configured to reflect a first portion of the light toward the transparent front panel while refracting a second portion of the light out of the light panel from the transparent back panel.

In some implementations, the at least one surface of the light guide is the front surface facing the transparent front panel, wherein the group of refractive elements is configured to refract a first portion of the light out of the light panel from the transparent front panel while reflecting a second portion of the light toward the transparent back panel.

In some implementations, the at least one surface of the light guide includes both the front surface of the light guide facing the transparent front panel and the back surface of the light guide facing the transparent back panel.

In some implementations, each of the group of refractive elements is configured as a microlens.

In some implementations, the group of refractive elements is arranged uniformly over the front surface of the light guide to produce a substantially uniform illumination from the light panel when the multiple LEDs are turned on.

In some implementations, the group of refractive elements is arranged such that the refractive elements are more densely distributed toward the middle and less densely distributed toward the edge of the front surface of the light guide to produce a uniform illumination from the light panel when the multiple LEDs are turned on.

In some implementations, the group of refractive elements is arranged into a predetermined pattern to produce a patterned illumination from the light panel when the multiple LEDs are turned on.

In some implementations, the group of refractive elements is arranged to produce a specific visual effect from the light panel when the multiple LEDs are turned on.

In some implementations, each element in the group of refractive elements is sufficiently small to achieve a transparency effect of the light panel to human eyes.

In some implementations, the at least one surface of the light guide is the back surface facing the transparent back panel, wherein the back surface includes a reflective structure for reflecting light emitted by the multiple LEDs into different angles.

In some implementations, the reflective structure includes a group of reflective elements, and each of the reflective elements reflects light through scattering.

In some implementations, each of the group of reflective elements is made of a highly-reflective scattering material such as titanium oxide (TiO₂).

In some implementations, the group of reflective elements is arranged uniformly over the back surface of the light guide to produce a substantially uniform illumination from the light panel when the multiple LEDs are turned on.

In some implementations, the group of reflective elements is arranged such that the reflective elements are more densely distributed toward the middle and less densely distributed toward the edge of the back surface of the light guide to produce a uniform illumination from the light panel when the multiple LEDs are turned on.

In some implementations, the group of reflective elements is arranged into a predetermined pattern to produce a patterned illumination from the light panel when the multiple LEDs are turned on.

In some implementations, the group of reflective elements is arranged to produce a specific visual effect from the light panel when the multiple LEDs are turned on.

In some implementations, each element in the group of reflective elements is sufficiently small to achieve a transparency effect of the light panel to human eyes.

In some implementations, the multiple LEDs include multi-colored LEDs operable to emit lights of different colors.

In some implementations, the light panel also includes a controller coupled to the multi-colored LEDs to control the emission of the multi-colored LEDs to enable a tunable color of illumination.

In some implementations, the light panel also includes one or more sensors coupled to the controller and configured to detect changes of ambient light, wherein the controller is configured to receive signals from the one or more sensors and to adjust illumination of the light panel according to the ambient light.

In some implementations, the controller adjusts illumination by adjusting intensity and color of the illumination.

In some implementations, the light guide is made of a transparent PMMA-based material.

In some implementations, the multiple LEDs include edge-emitting LEDs.

In another aspect, a light panel for producing an illumination or a visual effect includes: a transparent front panel; a transparent back panel; a side frame which supports the transparent front panel and the transparent back panel; multiple LEDs attached to an inner surface of the side frame; and a light guide positioned between the transparent front panel and the transparent back panel. This light guide is configured to propagate light emitted by the multiple LEDs, and to direct a portion of the light out of the light panel in a direction toward the transparent front panel. The light panel further includes a transparent sheet positioned between the light guide and the transparent back panel. This transparent sheet is patterned with a group of reflective elements for directing the portion of the light toward the transparent front panel. Notably, the light panel is substantially transparent when the multiple LEDs are turned off.

In some implementations, the group of reflective elements is arranged uniformly over the transparent sheet to produce a uniform illumination from the light panel when the multiple LEDs are turned on.

In some implementations, the group of reflective elements is arranged such that the reflective elements are more densely distributed toward the middle and less densely distributed toward the edge of the back surface of the light guide to produce a uniform illumination from the light panel when the multiple LEDs are turned on.

In some implementations, the group of reflective elements is arranged into a predetermined pattern to produce a patterned illumination from the light panel when the multiple LEDs are turned on.

In another aspect, a light window for producing an illumination or a visual effect includes a regular window including a glass panel and a window frame and a light panel positioned behind the glass panel and between the window frame. The light panel further includes: a transparent front panel; a transparent back panel; a side frame which supports the transparent front panel and the transparent back panel; multiple LEDs attached to an inner surface of the side frame; and a light guide positioned between the transparent front panel and the transparent back panel and configured to propagate light emitted by the multiple LEDs, and to direct a portion of the light out of the light panel in a direction toward the transparent front panel. The at least one surface of the light guide may be configured with either a refractive structure or a reflective structure for directing the portion of the light toward the transparent front panel. Notably, the light panel is substantially transparent when the multiple LEDs are turned off.

In some implementations, the light window is used as a window light on a building, and the light window is substantially transparent during the day time to let in the nature light.

In some implementations, the light window is used as a skylight on a building, and the light window is substantially transparent during the day time to let in the nature light.

In another aspect, a light window for producing an illumination or a visual effect includes a regular window including a glass panel and a window frame and a light panel positioned behind the glass panel and between the window frame. The light panel further includes: a transparent front panel; a transparent back panel; a side frame which supports the transparent front panel and the transparent back panel; multiple LEDs attached to an inner surface of the side frame; and a light guide positioned between the transparent front panel and the transparent back panel. The light guide is configured to propagate light emitted by the multiple LEDs, and to direct a portion of the light out of the light panel in a direction toward the transparent front panel. The light panel further includes a transparent sheet positioned between the light guide and the transparent back panel, wherein the transparent sheet is patterned with a group of reflective elements for directing the portion of the light toward the transparent front panel. Notably, the light panel is substantially transparent when the multiple LEDs are turned off. Moreover, the light window is substantially transparent during the day time to let in the nature light.

In yet another aspect, a light panel for producing an illumination or a visual effect includes: a light panel frame; two transparent panels spaced from each other and engaged to the light panel frame; light-emitting diodes (LEDs) engaged to the light frame and located to emit LED light into a space between the two transparent panels; and a transparent material positioned between the transparent panels and structured as a light guide to receive the LED light from the LEDs and to guide the received LED light within the transparent material while transmitting a portion of the received LED light out of the light guide towards one of the transparent panels to enable the light guide to appear as a bright opaque structure between the two transparent panels when the LEDs are turned on, and substantially transparent between the two transparent panels when the LEDs are turned off

In some implementations, at least one surface of the light guide includes a refractive structure or a reflective structure that directs light towards one of the two transparent panels.

The above and other aspects, and their implementations are described in greater detail in the drawings, the description and the claims.

### BRIEF DESCRIPTION OF THE DRAWINGS

FIG. 1 shows a side-view of a conventional light panel using edge-emitting LEDs as light sources.

FIG. 2 shows a side-view of an exemplary light panel using a light guide but without a reflective film in accordance with some embodiments described herein.

FIG. 3A shows both a top view and a side-view of a waveguide having a refractive structure comprising a predefined pattern of refractive elements in accordance with some embodiments described herein.

FIG. 3B shows both a top view and a side-view of a waveguide having a reflective structure comprising a predefined pattern of reflective elements in accordance with some embodiments described herein.

FIG. 4 shows a side-view of a color tunable light panel in accordance with some embodiments described herein.

FIG. 5 shows an example of integrating a light panel into a standard window to form a light window in accordance with some embodiments described herein.

FIG. 6A shows an example of using an integrated light window described in FIG. 5 during day time, when the light window behaves like a regular window of the building to let in the natural sun light in accordance with some embodiments described herein.

FIG. 6B shows an example of using an integrated light window described in FIG. 5 at night to illuminate an indoor area of a building in accordance with some embodiments described herein.

FIG. 7A shows an example of integrating a light panel closely with a regular skylight to form an integrated skylight in accordance with some embodiments described herein.

FIG. 7B shows an example of placing a light panel at some distance away from a regular skylight to form an integrated skylight in accordance with some embodiments described herein.

FIG. 8A shows a largely uniformly distributed refraction or reflective pattern to create a largely uniform illumination in accordance with some embodiments described herein.

FIG. 8B shows a non-uniformly distributed refraction or reflective pattern to create a more uniform illumination when the LEDs are located on either side of the light window in accordance with some embodiments described herein.

FIG. 8C shows the refraction or reflective elements arranged into a star pattern to create a patterned illumination in accordance with some embodiments described herein.

FIG. 8D shows the refraction or reflective elements arranged into an arrow pattern to create another patterned illumination, which can be used to indicate a direction.

FIG. 9A shows a side-view of light panel which includes a transparent patterned sheet in accordance with some embodiments described herein.

FIG. 9B shows reflective elements on a transparent patterned sheet arranged into a star pattern to create a patterned illumination in accordance with some embodiments described herein.

FIG. 9C shows reflective elements on a transparent patterned sheet arranged into an arrow pattern to indicate a direction.

FIG. 9D shows using a solid reflective star pattern on the transparent patterned sheet to create the same patterned illumination as FIG. 9B in accordance with some embodiments described herein.

FIG. 9E shows a solid reflective arrow pattern on the transparent patterned sheet to create the same patterned illumination as FIG. 9C in accordance with some embodiments described herein.

Like reference symbols and designations in the various drawings indicate like elements.

### DETAILED DESCRIPTION

LEDs can be used to create light panels (also referred to as “panel light” hereinafter) in part due to their high lumen efficiency, versatility in producing a wide range of colors, small in individual sizes and easiness to arrange a great number of LEDs into large configurations. Such light panels can be used as or be integrated with regular windows, skylights or other lighting fixtures or devices, including lighting installations on buildings for illumination, decoration, entertainment or advertisement purposes.

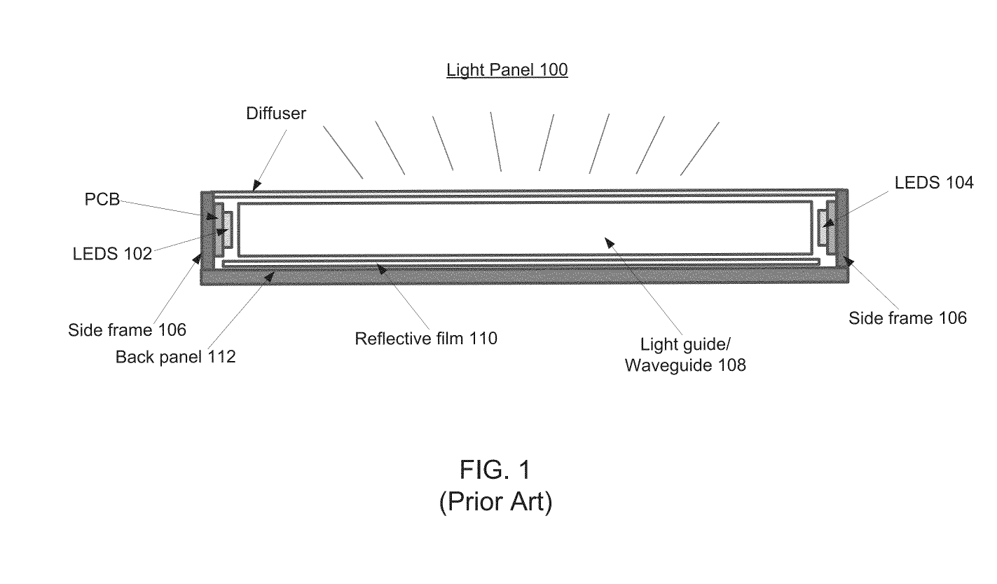

Various LED-based lighting panel configurations are available. FIG. 1 shows a side-view of an example of a light panel 100 using edge-emitting LEDs as light sources. The light panel 100 includes two strings of LED light sources 102 and 104 attached to a side frame 106 (which is composed of multiple sides), each string of LEDs is arranged in the direction perpendicular to the paper plane, and a light guide (also referred to as “waveguide” hereinafter) 108 positioned between the two string of LEDs to propagate the light from the LED light sources along the horizontal direction. In some implementations, LED light sources 102 and 104 are configured in edge-emitting mode and can emit either a single color or a tunable color. In some implementations, the light panel 100 can use light sources other than LED light sources.

In some implementations, the light guides/waveguides of the panel lights may be made of Poly(methyl methacrylate) (PMMA) slabs which are typically transparent to visible lights. To direct light out of the light guide 108 for illumination (i.e., in the upward direction), laser marks or printed marks may be created on one surface of the light guide 108 (e.g., the lower surface) to partially destroy total internal reflection (TIR) within the light guide. However, these marks usually have strong optical diffusion effect, i.e., significant amount of light (˜50%) will escape the light guide in the wrong direction (i.e., opposite to illumination direction). As a result, a reflective film 110, such as reflective paper from WhiteOptics™, is placed between the light guide 108 and a back panel 112 of the light panel 100 to reflect the escaping light back into the illumination direction. Due to the presence of the reflective film, the light panel appears opaque and is not transparent when the LED light is turned off.

Techniques, systems, and devices are disclosed for implementing a light window, a skylight or other lighting devices including light-emitting diode (LED) lights and a transparent waveguide for providing basic illumination, and for producing various coloring and visual effects on the window for decoration, entertainment or advertisement purposes. Instead of using diffusion marks on the light guide, the disclosed light panel for a light window uses a light guide configured with a refractive or a reflective structure, which comprises carefully designed refractive or reflective optical elements (e.g., having a shape of lens surface). In some embodiments, the proposed reflective elements include highly-reflective scattering elements such as titanium oxide (TiO₂) paint spots. Furthermore, by using patterned refractive or reflective structure, the illumination of the light window can provide additional new lighting experience.

Using the proposed light window designs, majority (e.g., >65%) of total LED outputs can be directed toward the desired illumination direction without using the reflective film. Hence, the proposed light window provides LED-based illumination when the LED lights are turned on. By further using a transparent back panel (which also provides protection to the light guide), the proposed light window is transparent to look like a regular window when LED light is off, and to let the natural light in during the day time. Hence, the proposed light window seamlessly combines the functions of a regular window and the functions of a light window into a single window. Notably, the proposed light window can still be used as regular panel light. However, the transparent nature of the light window design when LEDs are not turned on can eliminate “light cave” effect when the light panel is hang on a wall or suspended from a ceiling.

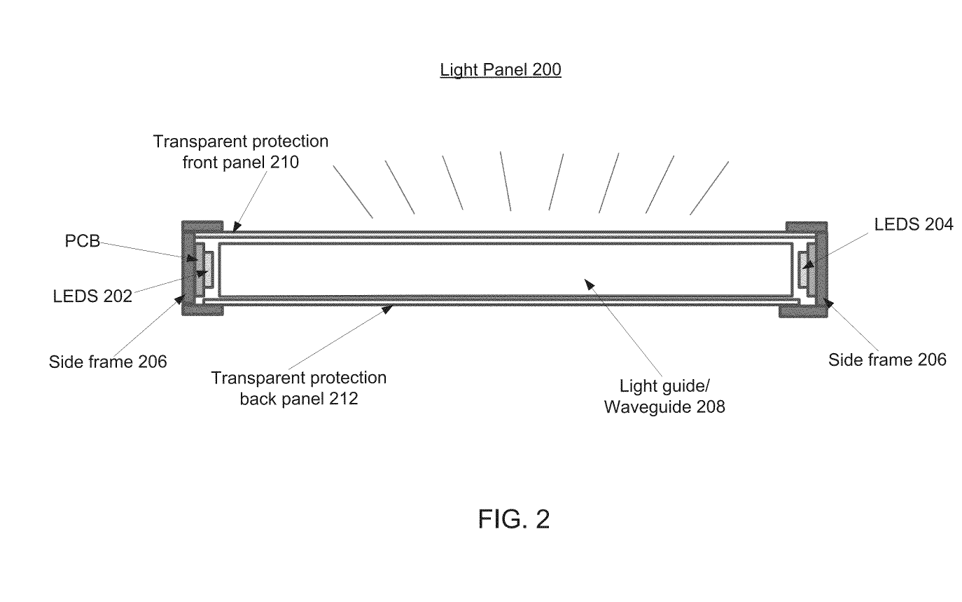

FIG. 2 shows a side-view of an exemplary light panel 200 using a light guide but without a reflective film in accordance with some embodiments described herein. As can be seen in FIG. 2, light panel 200 includes two strings of LED light sources 202 and 204 attached to the side frame 206 (shown with two sides), each string of LEDs includes multiple LEDs arranged in the direction perpendicular to the paper plane, and a transparent light guide/waveguide 208 positioned between the two strings of LEDs to propagate the light from the LED light sources along the horizontal direction. Light guide 208 may be made of a PMMA slab or other transparent waveguide materials. In some implementations, LED light sources 202 and 204 are configured in edge-emitting mode and can emit either a single color or a tunable color. In some implementations, a light panel 200 can use light sources other than LED light sources. Note that light panel 200 also includes a transparent front panel 210 and a transparent back panel 212, both may be used for protection purposes. Note also that unlike light panel 100, light panel 200 does not include a reflective film. Hence, the structure of light panel 200 is transparent when the LEDs are turned off. Typically, the light guide 208 does not require diffusion marks such as laser marks or printed marks on either of its surfaces.

Although two strings of LEDs are shown in FIG. 2, in some embodiments LEDs may be installed on only one side of the side frame 206. For example, a variation to light panel 200 may have strings of LEDs 202 but without LEDs 204. This may be the case when the light guide 208 is relatively narrow in the direction of light propagation. In some embodiments, additional LEDs may be installed along the other two edges of the light guide 208 perpendicular to the side fame 206. In general, strings of LEDs can be installed on one, two, three, or all four edges of the light guide 208.

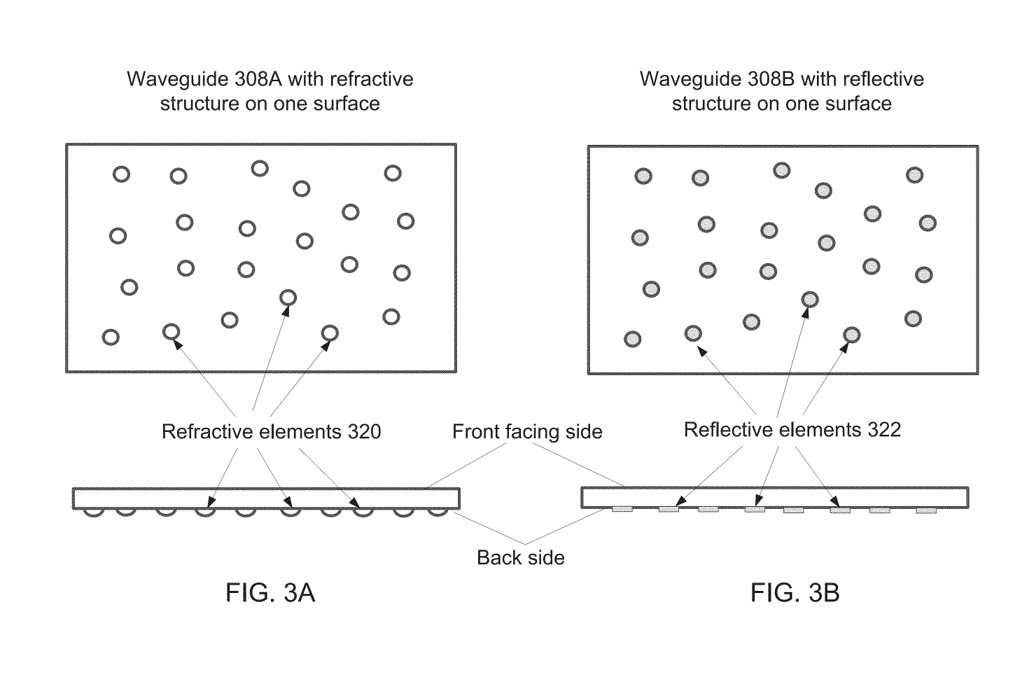

As mentioned above, light guide/waveguide 208 may be configured with a refractive structure or a reflective structure on one surface. FIGS. 3A and 3B show waveguides configured with a refractive structure or a reflective structure in accordance with some embodiments described herein. More specifically, FIG. 3A shows both a top view and a side-view of waveguide 308A having a refractive structure 320 comprising a predefined pattern of refractive elements. In the embodiment shown, the surface of the waveguide 308A which includes the refractive elements is the back surface facing the transparent back panel 212. These refractive elements partially destroy TIR at the back surface to effectuate a portion of the LED light propagating within the waveguide 308A to escape the waveguide from the back surface, and another portion of the LED light to escape the waveguide from the front surface. Note that these refractive elements can both refract some LED light out of the waveguide and reflect some LED light back into the waveguide. In some embodiments, each of the refractive elements 320 is configured as a microlens having a convex shape (i.e., microlens surface is above the flat back surface). Referring to both FIG. 3A and FIG. 2, it is noted that in some embodiments, instead of on the back surface as in FIG. 3A, refractive elements can be disposed on the front surface of the waveguide 208 facing the transparent front panel 210. In these embodiments, refractive elements in the form of concave microlens (i.e., microlens surface is below the flat front surface) may be used. In some other embodiments, refractive elements can be disposed on both the front surface and back surface of the waveguide 208. In general, the shape/size/density of the refractive elements and location of the refractive elements on the waveguide can be determined based on design requirements such as the transmission ratio of LED light of each of the waveguide surfaces.

FIG. 3B shows both a top view and a side-view of waveguide 308B having a reflective structure 322 comprising a predefined pattern of reflective elements. In particular, the surface of the waveguide 308B which includes the reflective elements is the back surface facing the transparent back panel 212 (in reference to light panel 200 in FIG. 2). In some implementations, these reflective elements are highly-reflective scattering elements that reflect light through scattering. These reflective elements facilitate portion of the LED light propagating within the waveguide 308B to be reflected toward the transparent front panel 210 (in reference to light panel 200 in FIG. 2) through diffuse reflection.

In FIGS. 3A and 3B, each group of refractive elements 320 and reflective elements 322 is uniformly distributed over the surface of the respective waveguide, for example, they can be arranged into an substantially evenly spaced two-dimensional array. In other implementations, a group of refractive elements or reflective elements is non-uniformly distributed over the surface of a given waveguide. More specifically, refractive elements or reflective elements may be more densely distributed toward the middle of the waveguide surface while more sparsely distributed toward the edges of the waveguide surface. Such a distribution of the refractive elements or reflective elements may effectuate more uniform illumination from the waveguide surface because the LED light sources are placed near the edges of the waveguide.

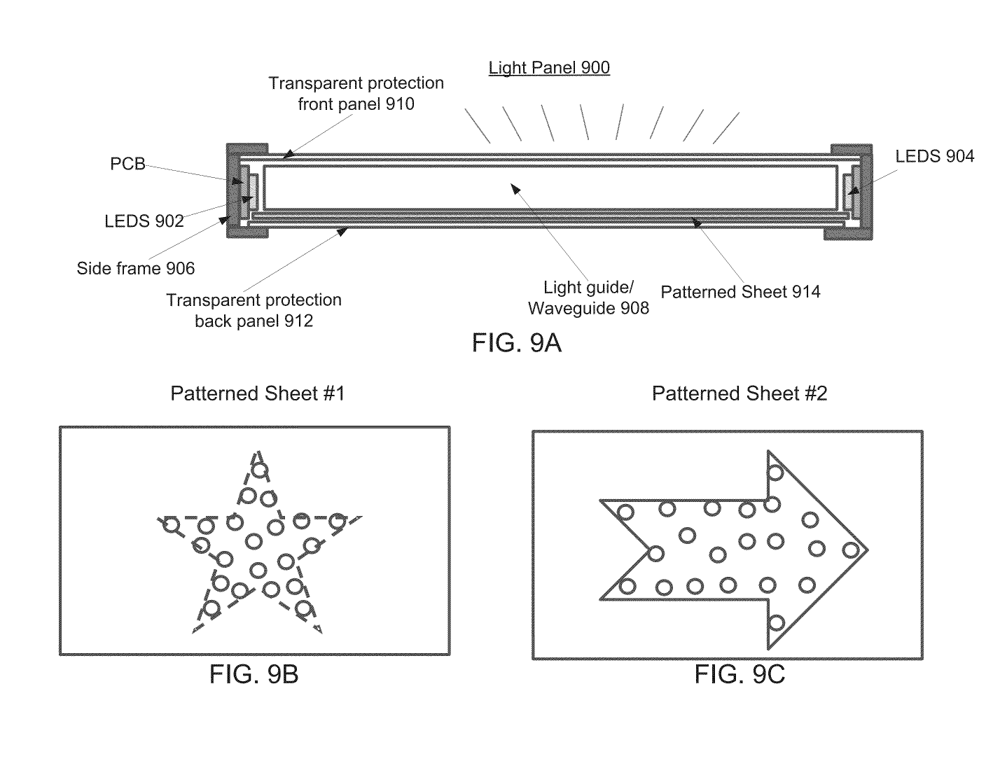

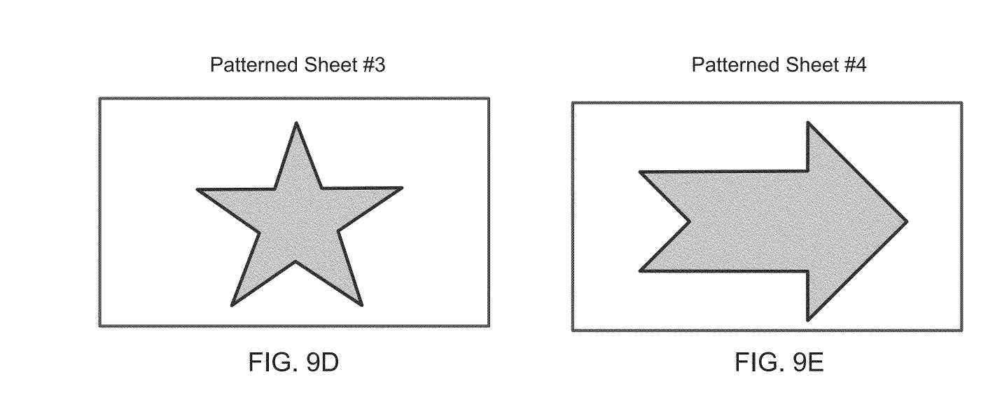

In some implementations, the reflective or refractive elements shown can be obtained by forming a predefined pattern on the waveguide surface. For example, refractive elements 320 can be formed by directly creating microlens structures on the waveguide surface. Separately, reflective elements 322 can be formed by directly applying a highly-reflective paint on the waveguide surface. In one embodiment, the highly-reflective paint is made of TiO₂ or other highly-reflective scattering material dispersed in a liquid. The TiO₂ paint is then applied over a screen comprising openings arranged in predefined patterns, wherein the paint will coat the areas on the waveguide surface at the locations of the openings. In some implementations, the additional reflective elements are not directly formed on a surface of the light guide/waveguide. Instead, a reflective structure can be generated by adding a transparent sheet having a patterned reflective structure formed using a reflective coating. This transparent sheet is then placed directly behind the waveguide described above (more detail of the patterned sheet is provided below in conjunction with FIG. 9).

To achieve good transparency effect to human eyes, the aforementioned refractive and reflective elements should be sufficiently small wherein the actual sizes may depend on how far away the light window is typically viewed from. For example, <1.0 mm element size may be used for 1 m viewing distance. Generally, the element size can be between 0.05 mm and 2 mm.

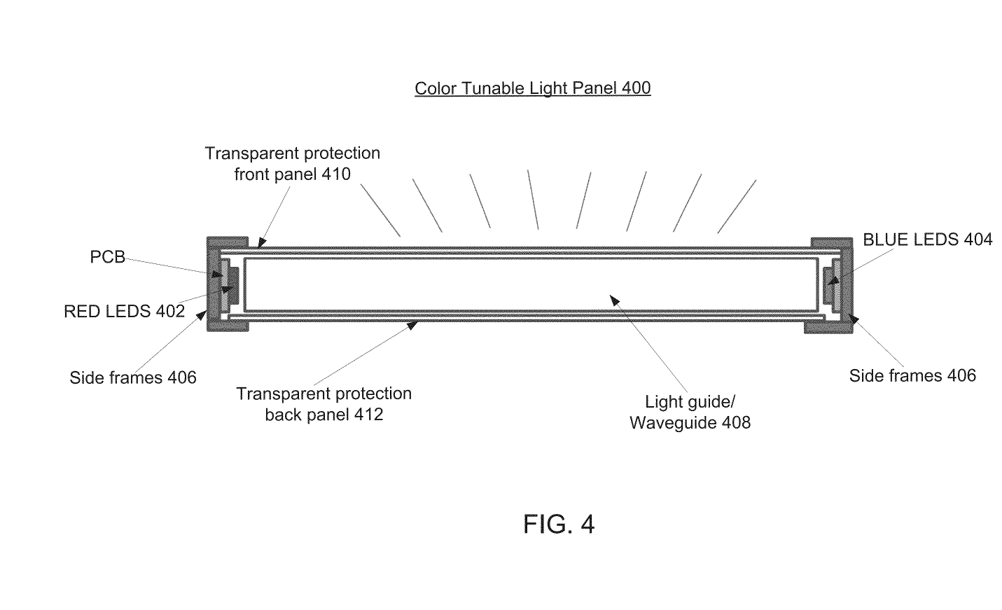

FIG. 4 shows a side-view of a color tunable light panel 400 in accordance with some embodiments described herein. Light panel 400 has substantially the same structure as light panel 200, including the light guide/waveguide 408, the transparent front and back panels 410 and 412, and without a reflective film. To achieve color tuning in light guide 408, multi-colored LEDs are used, for example, light panel 400 can include a string of red LEDs 402 and a string of blue LEDs 404. Although not shown, light panel 400 can include additional LEDs on each side of the light guide 408 of different colors, including, but are not limited to yellow, green, red, and blue. The multi-colored LEDs emit lights of different colors can be controlled by a control circuit. Under the control of the control circuit, specific colored emissions from these multi-colored LEDs are mixed within light guide 408 to produce desirable colors.

In some implementations, a window light or a skylight made of color tunable light panel 400 can be adjusted in real time to achieve high color rendering index (CRI), a quantitative measure of the ability of a light source to reveal the colors of various objects faithfully in comparison with an ideal or natural light source. More specifically, color tunable light panel 400 can use red, yellow (which are above blackbody) and blue LEDs which are controlled by a control circuit (not shown) to generate a desired illumination (of specific intensity and color) that are tunable based on time, ambient light and/or user input. Other embodiments of color tunable light panels can use red, green, and blue LEDs; or use red, green, blue, and yellow LEDs, or use any combination of red, green, blue, and yellow LEDs. The control circuit may receive monitored changes in ambient light from one or more optical sensors (not shown) integrated with the window light or the skylight.

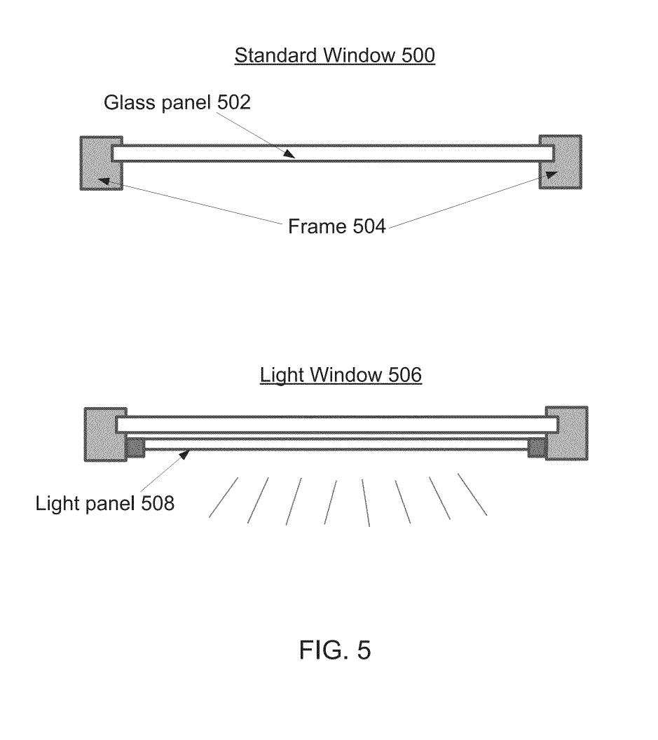

FIG. 5 shows an example of integrating a light panel into a standard window to form a light window in accordance with some embodiments described herein. The top plot in FIG. 5 shows a standard window 500, include a glass panel 502 and a frame 504. The bottom plot in FIG. 5 shows an exemplary integrated light window 506, wherein the above described light panel 508 is placed directly behind the glass panel 502 and between the frame 504 of standard window 500.

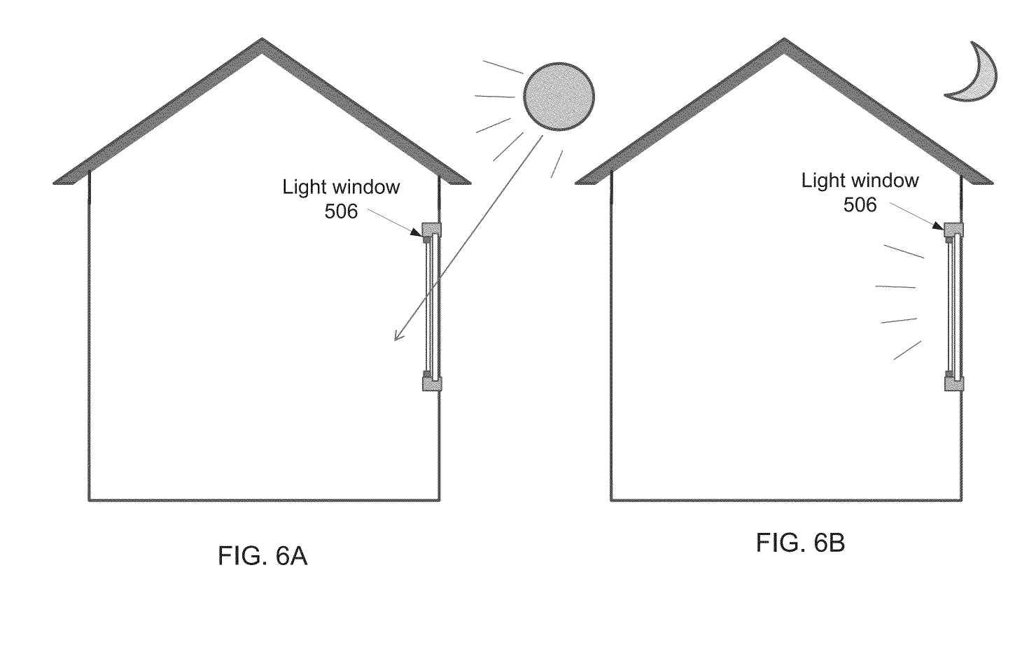

FIGS. 6A-6B show an example of using an integrated light window 506 described in FIG. 5 to illuminate an indoor area of a building in accordance with some embodiments described herein. More specifically, FIG. 6A shows a scenario at day time, when light sources in light window 506 are turned off, and as such light window 506 behaves like a regular window of the building to let in the natural sun light. FIG. 6B shows a scenario at night time, when the light sources in light window 506 are turned on, and used to illuminate the indoor area of the building.

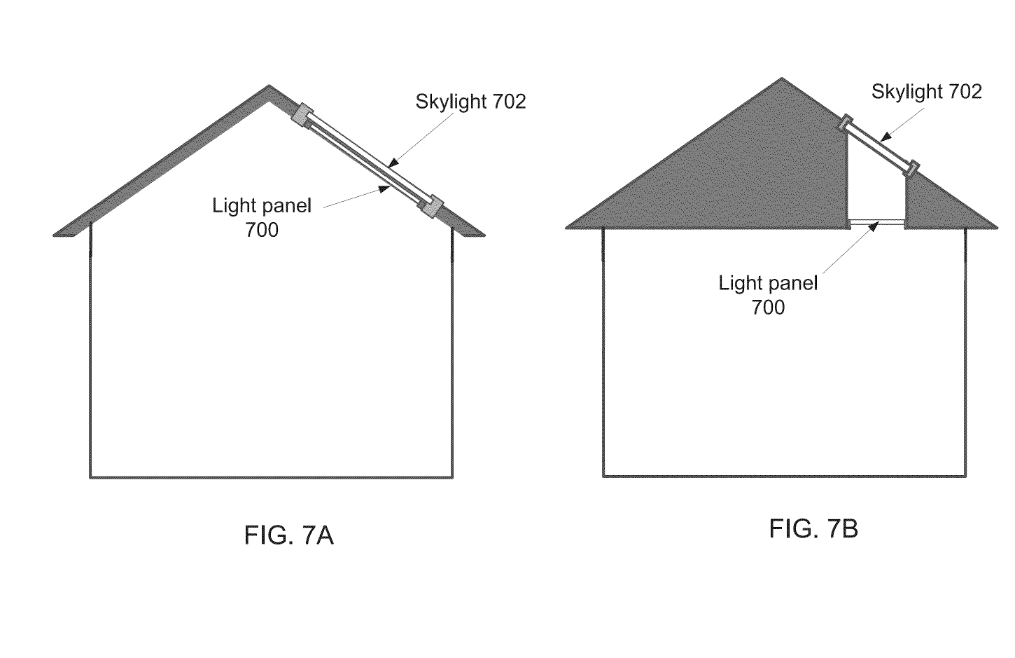

FIGS. 7A-7B show an example of integrating a light panel 700 with a regular skylight 702 in accordance with some embodiments described herein. Note that light panel 700 can include one of the above described light panels 200 or 400. More specifically, FIG. 7A shows a scenario where the light panel 700 is integrated closely with the regular skylight 702 to form an integrated skylight. This scenario may be used when there is no other structural support for the light panel below the regular skylight 702. FIG. 7B shows a scenario wherein light panel 700 is placed some distance away from the regular skylight 702, but closer to the inner space of the room. This scenario is feasible when there is some structural support for the light panel below the regular skylight 702.

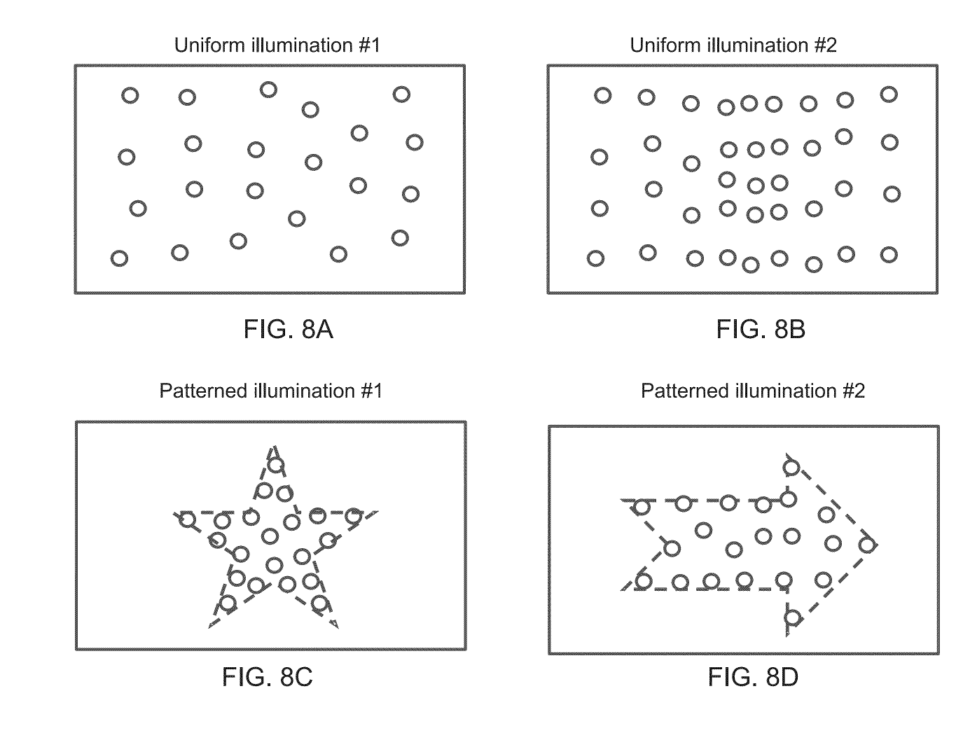

Note that in the proposed light window design, each of the refractive elements or the reflective elements on the waveguide surface appears like a point source. In some implementations, these refractive elements or the reflective elements on the light window can be arranged into different patterns to create patterned illumination. FIGS. 8A-8D shows using the refraction or reflective elements to create uniform or various patterned illumination on the light window in accordance with some embodiments described herein. In these figures, each circle can represent either a refractive element or a reflective element.

More specifically, FIG. 8A shows a largely uniformly distributed refraction or reflective pattern to create a largely uniform illumination in accordance with some embodiments described herein. FIG. 8B shows a non-uniformly distributed refraction or reflective pattern to create a more uniform illumination when the LEDs are located on either side of the light window in accordance with some embodiments described herein. More specifically, refraction or reflective elements are more densely distributed in the middle of the light window while more sparsely distributed near the left and right edges of the light window. FIG. 8C shows the refraction or reflective elements arranged into a star pattern to create a patterned illumination in accordance with some embodiments described herein. FIG. 8D shows the refraction or reflective elements arranged into an arrow pattern to create another patterned illumination, which can be used to indicate a direction. FIGS. 8C-8D provide only some simple examples of configuring a light window illumination effects. Hence, using refraction or reflective elements on the light guide surfaces offers the opportunity to create various patterned illuminations and visual effects for the viewer.

In implementing the disclosed technology, the reflective elements can be either formed directly on the waveguide surface, or they can be made on a transparent sheet which is subsequently placed directly behind the light guide within a light panel. FIG. 9A shows a side-view of light panel 900 which includes a transparent patterned sheet in accordance with some embodiments described herein. Light panel 900 has substantially the same structure as light panel 200, including strings of LEDs 902 and 904, side frame 906, light guide/waveguide 908, the transparent front and back panels 910 and 912, and without using a reflective film. However, unlike light guide 208 in FIG. 2 which is configured with a refractive structure or a reflective structure on one of the surfaces, light guide 908 may not have such a refractive or reflective structure on one of its surfaces. Instead, light panel 900 includes a transparent patterned sheet 914 positioned between the back panel 912 and the waveguide 908. Patterned sheet 914 may be patterned with reflective dots, wherein each of which appears like a point source.

In some implementations, the reflective elements on the patterned sheet can be arranged into different patterns to create patterned illumination. FIGS. 9B-9C show examples of using the reflective elements on the patterned sheet to create various patterned illumination on the light panel in accordance with some embodiments described herein. In these figures, each circle can represent a reflective element. More specifically, FIG. 9B shows reflective elements on the transparent patterned sheet 914 arranged into a star pattern to create a first patterned illumination. FIG. 9C shows the reflective elements on the transparent patterned sheet 914 arranged into an arrow pattern to create a second patterned illumination, which can be used to indicate a direction. Hence, using patterned sheet placed behind the light guide, the light panel can be configured to create various patterned illuminations and visual effects for the user.

FIGS. 9D-9E show examples for using a solid reflective pattern on the patterned sheet to create various patterned illumination on the light panel in accordance with some embodiments described herein. More specifically, FIG. 9D shows a reflective star pattern on the transparent patterned sheet 914 to create the same first patterned illumination. However, instead of using tiny reflective elements to form the star pattern as in FIG. 9C, the reflective pattern in FIG. 9D is a solid reflector which is not transparent. FIG. 9E shows a reflective arrow pattern on the transparent patterned sheet 914 to create the same second patterned illumination. However, instead of using tiny reflective elements to form the arrow pattern as in FIG. 9C, the reflective pattern in FIG. 9E is a solid reflector which is not transparent. Hence, in the examples of FIGS. 9D-9E, the light panel 900 using such patterned sheets is only transparent in the areas outside of the reflective patterns even when the LEDs are turned off.

Techniques, systems, and devices described above provide a light window or a skylight having LED light sources and a transparent waveguide to produce patterned illuminations, various coloring and visual effects on the light window or the skylight. The proposed light window or skylight includes a light panel which further includes a light guide/waveguide which does not require laser marks or printed marks. The proposed light guide includes a refractive or a reflective structure on a surface of the light guide, wherein the refractive or the reflective structure is configured with a predetermined pattern. Such design may reduce the cost of a light window (e.g., due to the removal of the reflective film from the light panel) while providing additional new lighting experience. The refractive or the reflective structures can be used to create patterned illumination without reduce optical output and efficacy. Certain uniform patterned illumination also allows for spatial intensity uniformity over whole emission surface.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A light panel for producing an illumination or a visual effect, comprising:
a transparent front panel;
a transparent back panel;
a side frame which supports the transparent front panel and the transparent back panel;
multiple light-emitting diodes (LEDs) attached to an inner surface of the side frame; and
a light guide positioned between the transparent front panel and the transparent back panel, wherein the light guide is configured to propagate light emitted by the multiple LEDs, and direct a portion of the light out of the light panel in a direction toward the transparent front panel, wherein at least one surface of the light guide is configured with either a refractive structure or a reflective structure for directing the portion of the light toward the transparent front panel; and
wherein the light panel is substantially transparent between the front and back panels when the multiple LEDs are turned off.

2. The light panel of claim 1, wherein the at least one surface of the light guide includes a refractive structure composed of a group of refractive elements for both refracting and reflecting light emitted by the multiple LEDs into different angles.

3. The light panel of claim 2, wherein the at least one surface of the light guide is the back surface facing the transparent back panel, wherein the group of refractive elements is configured to reflect a first portion of the light toward the transparent front panel while refracting a second portion of the light out of the light panel from the transparent back panel.

4. The light panel of claim 2, wherein the at least one surface of the light guide is the front surface facing the transparent front panel, wherein the group of refractive elements is configured to refract a first portion of the light out of the light panel from the transparent front panel while reflecting a second portion of the light toward the transparent back panel.

5. The light panel of claim 2, wherein the at least one surface of the light guide includes both the front surface of the light guide facing the transparent front panel and the back surface of the light guide facing the transparent back panel.

6. The light panel of claim 2, wherein each of the group of refractive elements is configured as a microlens.

7. The light panel of claim 2, wherein the group of refractive elements is arranged uniformly over the front surface of the light guide to produce a substantially uniform illumination from the light panel when the multiple LEDs are turned on.

8. The light panel of claim 2, wherein the group of refractive elements is arranged such that the refractive elements are more densely distributed toward the middle and less densely distributed toward the edge of the front surface of the light guide to produce a uniform illumination from the light panel when the multiple LEDs are turned on.

9. The light panel of claim 2, wherein the group of refractive elements is arranged into a predetermined pattern to produce a patterned illumination from the light panel when the multiple LEDs are turned on.

10. The light panel of claim 2, wherein the group of refractive elements is arranged to produce a specific visual effect from the light panel when the multiple LEDs are turned on.

11. The light panel of claim 2, wherein each element in the group of refractive elements is sufficiently small to achieve a transparency effect of the light panel to human eyes.

12. The light panel of claim 1, wherein the at least one surface of the light guide is the back surface facing the transparent back panel, wherein the back surface includes a reflective structure for reflecting light emitted by the multiple LEDs into different angles.

13. The light panel of claim 12, wherein the reflective structure comprises a group of reflective elements, and wherein each of the reflective elements reflects light through scattering.

14. The light panel of claim 13, wherein each of the group of reflective elements is made of a highly-reflective scattering material such as titanium oxide (TiO₂).

15. The light panel of claim 13, wherein the group of reflective elements is arranged uniformly over the back surface of the light guide to produce a substantially uniform illumination from the light panel when the multiple LEDs are turned on.

16. The light panel of claim 13, wherein the group of reflective elements is arranged such that the reflective elements are more densely distributed toward the middle and less densely distributed toward the edge of the back surface of the light guide to produce a uniform illumination from the light panel when the multiple LEDs are turned on.

17. The light panel of claim 13, wherein the group of reflective elements is arranged into a predetermined pattern to produce a patterned illumination from the light panel when the multiple LEDs are turned on.

18. The light panel of claim 13, wherein the group of reflective elements is arranged to produce a specific visual effect from the light panel when the multiple LEDs are turned on.

19. The light panel of claim 13, wherein each element in the group of reflective elements is sufficiently small to achieve a transparency effect of the light panel to human eyes.

20. The light panel of claim 1, wherein the multiple LEDs include multi-colored LEDs operable to emit lights of different colors.

21. The light panel of claim 20, further comprising a controller coupled to the multi-colored LEDs, wherein the controller is configured to control the emission of the multi-colored LEDs to enable a tunable color of illumination.

22. The light panel of claim 21, further comprising one or more sensors coupled to the controller and configured to detect changes of ambient light, wherein the controller is configured to receive signals from the one or more sensors and to adjust illumination of the light panel according to the ambient light.

23. The light panel of claim 22, wherein adjusting illumination involves adjusting intensity and color of the illumination.

24. The light panel of claim 1, wherein the light guide is made of a transparent PMMA-based material.

25. The light panel of claim 1, wherein the multiple LEDs include edge-emitting LEDs.

26. A light panel for producing an illumination or a visual effect, comprising:
a transparent front panel;
a transparent back panel;
a side frame which supports the transparent front panel and the transparent back panel;
multiple light-emitting diodes (LEDs) attached to an inner surface of the side frame;
a light guide positioned between the transparent front panel and the transparent back panel, wherein the light guide is configured to propagate light emitted by the multiple LEDs, and to direct a portion of the light out of the light panel in a direction toward the transparent front panel; and
a transparent sheet positioned between the light guide and the transparent back panel, wherein the transparent sheet is patterned with a group of reflective elements for directing the portion of the light toward the transparent front panel, wherein the light panel is substantially transparent when the multiple LEDs are turned off.

27. The light panel of claim 26, wherein the group of reflective elements is arranged uniformly over the transparent sheet to produce a uniform illumination from the light panel when the multiple LEDs are turned on.

28. The light panel of claim 26, wherein the group of reflective elements is arranged such that the reflective elements are more densely distributed toward the middle and less densely distributed toward the edge of the back surface of the light guide to produce a uniform illumination from the light panel when the multiple LEDs are turned on.

29. The light panel of claim 26, wherein the group of reflective elements is arranged into a predetermined pattern to produce a patterned illumination from the light panel when the multiple LEDs are turned on.

30. The light panel of claim 26, wherein the multiple LEDs include multi-colored LEDs operable to emit lights of different colors.

31. The light panel of claim 30, further comprising a controller coupled to the multi-colored LEDs, wherein the controller is configured to control the emission of the multi-colored LEDs to enable a tunable color of illumination.

32. The light panel of claim 31, further comprising one or more sensors coupled to the controller and configured to detect changes of ambient light, wherein the controller is configured to receive signals from the one or more sensors and to adjust illumination of the light panel according to the ambient light.

33. The light panel of claim 26, wherein the multiple LEDs include edge-emitting LEDs.

34. A light window for producing an illumination or a visual effect, comprising:
a regular window including a glass panel and a window frame;
a light panel positioned behind the glass panel and between the window frame, the light panel including:
a transparent front panel;
a transparent back panel;
a side frame which supports the transparent front panel and the transparent back panel;
multiple light-emitting diodes (LEDs) attached to an inner surface of the side frame; and
a light guide positioned between the transparent front panel and the transparent back panel, wherein the light guide is configured to propagate light emitted by the multiple LEDs, and direct a portion of the light out of the light panel in a direction toward the transparent front panel, wherein at least one surface of the light guide is configured with either a refractive structure or a reflective structure for directing the portion of the light toward the transparent front panel; and
wherein the light panel is substantially transparent to a viewer when the multiple LEDs are turned off.

35. The light window of claim 32, wherein the light window is used as a window light on a building, and wherein the light window is substantially transparent during the day time to let in the nature light.

36. The light window of claim 32, wherein the light window is used as a skylight on a building, and wherein the light window is substantially transparent during the day time to let in the nature light.

37. A light window for producing window light, comprising:
a regular window including a glass panel and a window frame;
a light panel positioned behind the glass panel and between the window frame, the light panel including:
a transparent front panel;
a transparent back panel;
a side frame which supports the transparent front panel and the transparent back panel;
multiple light-emitting diodes (LEDs) attached to an inner surface of the side frame;
a light guide positioned between the transparent front panel and the transparent back panel, wherein the light guide is configured to propagate light emitted by the multiple LEDs, and direct a portion of the light out of the light panel in a direction toward the transparent front panel;
and a transparent sheet positioned between the light guide and the transparent back panel, wherein the transparent sheet is patterned with a group of reflective elements for directing the portion of the light toward the transparent front panel, wherein the light panel is substantially transparent to a viewer when the multiple LEDs are turned off.

38. The light window of claim 37, wherein the light window is used as a window light on a building, and wherein the light window is substantially transparent during the day time to let in the nature light.

39. The light window of claim 37, wherein the light window is used as a skylight on a building, and wherein the light window is substantially transparent during the day time to let in the nature light.

40. A light panel for producing an illumination or a visual effect, comprising:
a light panel frame;
two transparent panels spaced from each other and engaged to the light panel frame;
light-emitting diodes (LEDs) engaged to the light frame and located to emit LED light into a space between the two transparent panels; and
a transparent material positioned between the transparent panels and structured as a light guide to receive the LED light from the LEDs and to guide the received LED light within the transparent material while transmitting a portion of the received LED light out of the light guide towards one of the transparent panels to enable the light guide to appear as a bright opaque structure between the two transparent panels when the LEDs are turned on, and substantially transparent between the two transparent panels when the LEDs are turned off.

41. The light panel as in claim 40, wherein at least one surface of the light guide includes a refractive structure or a reflective structure that directs light towards one of the two transparent panels.
